(19) United States
(12) Patent Application Publication
(10) Pub. No.: US 2009/0084206 A1
(43) Pub. Date: Apr. 2, 2009

(54) Cam slider-returning mechanism

(75) Inventor: Takashi Shibata, Tokyo (JP)

Correspondence Address: WENDEROTH, LIND & PONACK, L.L.P., 2033 K STREET N. W., SUITE 800, WASHINGTON, DC, 20006-1021, US

(73) Assignee: Sankyo Oilless Industry, Inc.

(21) Appl. No.: 12/230,917

(22) Filed: Sep. 8, 2008

(30) Foreign Application Priority Data
Oct. 2, 2007 (JP) 2007-258527

(51) Int. Cl. F16C 29/02

(52) U.S. Cl. 74/110

(57) ABSTRACT

Disclosed a mechanism for returning a cam slider in a press tool to its original position after the slider has been slid in the direction of machining. The mechanism is made of an accommodation space portion, a resilient member withdrawably received in the space portion extending in the direction in which the cam slider moves, insertion holes formed on both sidewalls of the space portion near its rear end, and a lock plate subassembly capable of being inserted in the insertion holes. The accommodation space portion is formed in a lower portion of the cam slider or under the slider, and has rear and front surfaces being open. The insertion holes extend in a direction perpendicular to the longitudinal direction of the space portion. The lock plate subassembly provides a cover over at least a part of the space portion and supports the rear end of the resilient member.

### BACKGROUND OF THE INVENTION

1. Field of the Invention

The present invention relates to a press tool for performing press molding to punch holes in a work such as an automotive body panel or to bend the work. More specifically, the invention relates to a mechanism for returning a cam slider to its original position after the slider was moved during press molding.

2. Prior Art

A known press tool used for punching or bending of automotive body panels is composed of a cam driver moving up and down, a cam slider having a tilted cam surface, and a cam base supporting the cam slider. The cam slider is made to slide in the direction in which machining is done while the cam surface is in sliding contact with the cam driver. The cam base guides the sliding motion of the cam slider. A mechanism for returning the cam slider having a resilient member is described, for example, in JP-A-2004-237320 and JP-A-08-19825. The cam slider-returning mechanism is mounted on the cam slider. The resilient member pushes the cam slider back to its original position after the cam slider has been moved in the direction of machining by the repulsive force produced from one end of the cam base.

This conventional cam slider-returning mechanism is composed, for example, of a guide rod 21 for preventing shifting of the resilient member, a coil spring 22 being a resilient member acting to bias the cam slider in the returning direction, a receiving plate 23, a returning plate 24a, and a support plate 25 as shown in FIG. 11. Where this cam slider-returning mechanism is mounted on the cam slider, it is desired that an opening be formed behind the cam slider and that the resilient member 22 can be taken out rearward if exchange or other maintenance of the resilient member 22 is taken into consideration.

However, where the opening permitting the resilient member to be taken out is covered by a cover member, for example, by tightening a setscrew or other component, the cover member is always pushed by the resilient member. Under this condition, the cover member tends to loosen due to vibrations. When the cover member is removed for maintenance or so, there is the danger that the resilient member inadvertently springs out because resilient force is left in the resilient member for some cause, thus injuring the worker.

### SUMMARY OF THE INVENTION

Accordingly, it is an object of the present invention to provide a cam slider-returning mechanism which solves the foregoing problem with the prior art and which prevents the resilient member from springing out inadvertently.

A cam slider-returning mechanism according to the present invention is for use with a press tool having a cam driver capable of moving up and down, a cam slider having a tilted cam surface making sliding contact with the cam driver to permit the cam driver to slide in the direction of machining, a cam base supporting the cam slider and guiding sliding motion of the cam slider, and a returning mechanism for returning the cam slider to its original position after the cam slider has been slid in the direction of machining. The cam slider-returning mechanism has at least one accommodation space portion formed in a lower portion of the cam slider or under the cam slider and extending in the direction of motion of the cam slider, at least one resilient member withdrawably accommodated in the accommodation space portion, insertion holes formed in both sidewalls of the accommodation space portion near its rear end and extending in a direction perpendicular to the longitudinal direction of the accommodation space portion, and a lock plate subassembly capable of being inserted in the insertion holes. The accommodation space portion has front and rear sides that are open. The lock plate subassembly plugs up at least a part of the accommodation space portion and supports the rear end of the resilient member.

Preferably, the lock plate subassembly is provided with a hole permitting visual check of the inside of the accommodation space portion in which the resilient member is received. Furthermore, the lock plate subassembly is preferably made of two lock plates each made of a flat plate. Each of the two lock plates has a front-end portion provided with a recessed portion. Preferably, the recessed portions of the two lock plates are abutted against each other to form the hole permitting the visual check. Furthermore, preferably, the recessed portions at the front-end portions of the lock plates substantially conform to a part of the cross-sectional shape of the accommodation space portion.

The insertion holes may be tilted downward toward the axis of the accommodation space portion. Preferably, the lock plate subassembly is held by means of holding means after being loosely fitted in the insertion holes. In addition, the lock plate subassembly is moved outwardly such that the resilient member can be taken out of the accommodation space portion. Under this condition, the lock plate subassembly is so shaped that it does not protrude outwardly from a maximum lateral width defined by both side surfaces (as viewed from the direction of machining) of the cam slider. This is preferable for high-density arrangement of press tools.

Where the resilient member is plural in number and juxtaposed and the accommodation space portion is plural in number and juxtaposed, the lock plate subassembly is preferably made of end lock plates disposed on opposite ends of the insertion holes and a central lock plate disposed between the end lock plates. The accommodation space portions are covered except for the hole for visual check.

According to the cam slider-returning mechanism of the present invention, if resilient force possessed by the resilient member and acting to return the cam slider to its original position is left in the resilient member after the cam slider has been returned to its original position for some cause, the lock plate subassembly can prevent the resilient member from springing out of the accommodation space portion.

When the holding means is loosened or removed to take out the lock plate subassembly, the resilient member pushes the lock plate subassembly rearward against the rear wall surface of the insertion holes. The resulting frictional force makes it difficult to take out the lock plate subassembly. Consequently, the worker can immediately recognize that the resilient member is not in its normal state. Therefore, the worker can sense the danger, preventing a trouble such as launch of the cover member.

The lock plate subassembly is provided with a hole for visual check to permit one to observe the inside of the accommodation space portion in which the resilient member is received from the opening and so it is easy to check the inside of the accommodation space portion from the outside during maintenance.

The lock plate subassembly can be separated into left and right parts and extracted from the insertion holes by fabricating the lock plate subassembly from two lock plates each made of a flat plate, forming recessed portions in front-end portions of the lock plates, and bringing the recessed portions into abutment with each other to form the hole for visual check. Therefore, the amount by which the lock plate subassembly is moved laterally to extract it is reduced. Consequently, the adjacent press tool will not create a hindrance. Rather, a press tool can be mounted nearby. Additionally, the amount of extraction can be reduced further by shaping the recessed portions into forms substantially conforming to parts of the cross-sectional shape of the accommodation space portion.

The lock plate subassembly can be easily inserted into the insertion holes by tilting the holes downward toward the axis of the accommodation space portion. If the holding means is removed, it is unlikely that the lock plate subassembly will slide by itself laterally and disengages.

Because the lock plate subassembly is held within the insertion holes by the holding means after being loosely inserted in the insertion holes, the lock plate subassembly can be easily held from behind the cam slider.

The both end surfaces of the lock plate subassembly can be confined within the end surface positions defining the maximum lateral width of the cam slider while the end surfaces are opened outwardly to permit the resilient member to be withdrawn from the opening. This is convenient to place the press tool nearby. The lock plate subassembly is one unit of the press tool and has no protrusions on its side surfaces and hence is compact. The cam mechanism can be stocked or packaged easily.

Where the resilient member is plural in number and juxtaposed and the accommodation space portion is plural in number and juxtaposed, the lock plate subassembly can be similarly mounted by fabricating the lock plate subassembly from end lock plates disposed on opposite end portions of the insertion holes and a central lock plate disposed between the end lock plates and providing a cover over the accommodation space portions except for the hole for visual check.

### BRIEF DESCRIPTION OF THE DRAWINGS

FIG. 1 is a side elevation view of a press tool using a cam slider-returning mechanism according to a first embodiment of the present invention;

FIG. 2 is a perspective view of a cam slider equipped with the cam slider-returning mechanism in FIG. 1;

FIG. 3 is an exploded perspective view of the cam slider;

FIG. 4 is a side elevation of the cam slider;

FIG. 5A is a cross-sectional view taken on line 5A-5A in FIG. 4;

FIG. 5B is a cross-sectional view taken on line 5B-5B in FIG. 4;

FIG. 5C is a cross-sectional view similar to FIG. 5B, but in which the lock plate subassembly has been opened;

FIG. 6 shows rear views of a cam slider equipped with a cam slider-returning mechanism according to a second embodiment of the present invention;

FIG. 7 is a vertical cross section of insertion holes formed in a cam slider equipped with a cam slider-returning mechanism according to a third embodiment of the invention;

FIGS. 8A, 8B, 8C, and 8D are vertical cross sections of cam slider-returning mechanism according to the third embodiment of the invention;

FIGS. 9A and 9B are side elevations of other examples of the lock plate subassembly and the insertion hole of the cam slider-returning mechanism;

FIGS. 10A and 10B are side elevations showing examples of the method of holding the lock plate subassembly; and

FIG. 11 is a vertical cross section of a conventional cam slider-returning mechanism.

### DETAILED DESCRIPTION OF THE PREFERRED EMBODIMENTS

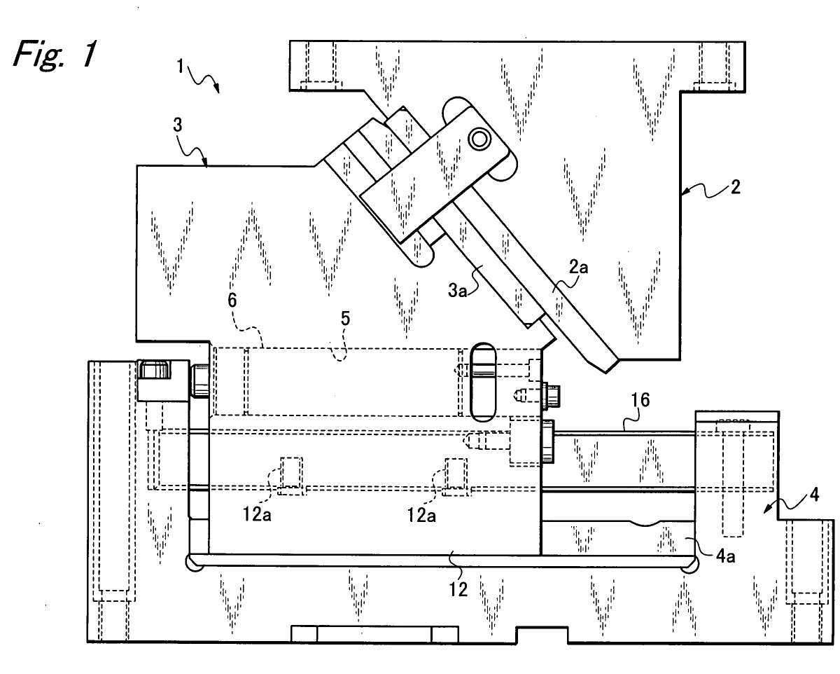

Referring to FIG. 1, a cam slider-returning mechanism according to a first embodiment of the present invention is for use with a press tool 1 including a cam driver 2 moving up and down, a cam slider 3, and a cam base 4 supporting the cam slider 3 and guiding its sliding motion. The cam driver 2 has a tilted cam surface 2a. Similarly, the cam slider 3 has a tilted cam surface 3a. The cam surface 3a of the cam slider 3 makes sliding contact with the cam surface 2a of the cam driver 2 and is slid in the direction of machining. The cam slider-returning mechanism operates to return the cam slider 3 to its initial position after a machining operation. An accommodation space portion 5 is formed in a lower portion of the cam slider 3. The cam slider-returning mechanism includes a resilient member 6 accommodated in the accommodation space portion 5, insertion holes 10 formed in sidewalls of the accommodation space portion 5 near its rear end, and lock plates 8a, 8b capable of being inserted into the insertion holes 10, respectively. In FIG. 1, the cam driver 2 is in its bottom dead point, i.e., its lower limit position.

The accommodation space portion 5 is a through hole formed in the lower portion of the cam slider 3 and extends through the lower portion in the direction of machining, i.e., in the longitudinal direction. The space portion 5 is shaped cylindrically in conformity with the shape of the resilient member 6. In the present embodiment, a gas cylinder is used as the resilient member 6. The front opening of the accommodation space portion 5 is covered by a cover member 7 having a through hole 7a through which the piston rod 6a of the gas cylinder 6 can protrude. The cam slider 3 has a front surface 3b on which a machine tool is mounted. In the present embodiment, the accommodation space portion 5 is formed integrally with the cam slider 3. Alternatively, sidewalls may be formed on the side of the cam base 4, and the accommodation space portion may be formed in the sidewalls. The resilient member can be made of a coil spring or resilient resinous body (such as synthetic rubber) other than the gas cylinder 6.

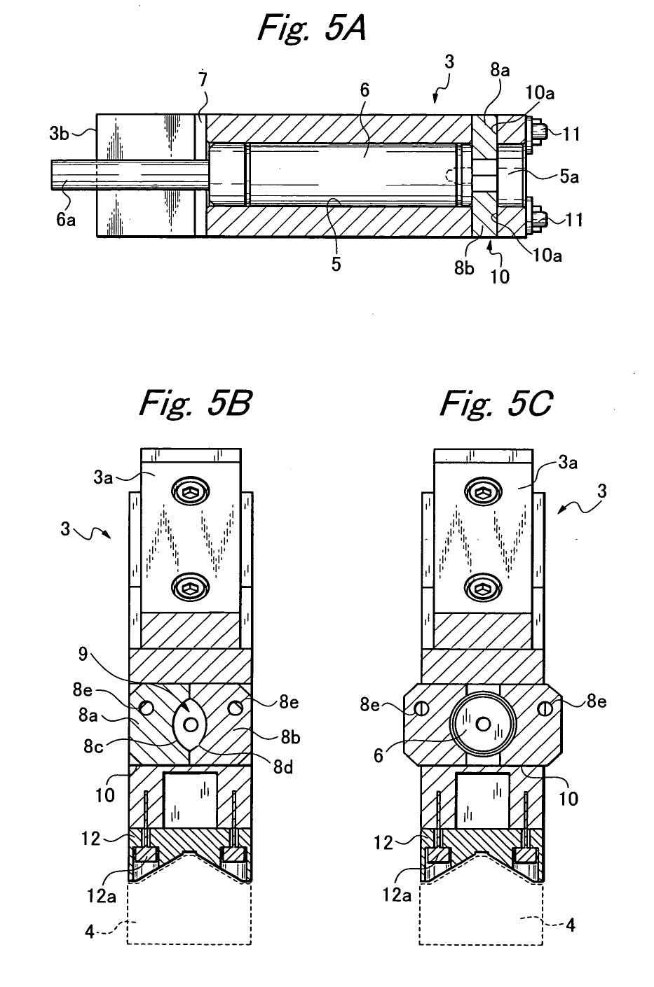

A guide member 12 provided with an inverted V-groove is held to the bottom of the cam slider 3 with bolts 12a (see FIGS. 5B and 5C) to achieve stable sliding motion. The cam base 4 has a cone-shaped guide portion 4a corresponding to the inverted V-groove of the guide member 12 on which the guide member 12 is placed. A guide hole 3c having a rectangular cross section is formed in the lower portion of the cam slider 3 and extends longitudinally in a parallel relation to the guide member 12. A guide rod 16 held to the cam base 4 is inserted in the guide hole 3c. The cam slider 3 is so mounted that it can slide longitudinally without rattling along the guide rod 16.

The gas cylinder 6 is inserted into and withdrawn from the opening 5a on the rear side end of the accommodation space portion 5. The insertion holes 10 formed in the sidewalls of the space accommodation portion 5 near its rear end are made of slots elongated vertically in conformity with the cross-sectional shape of the lock plates 8a and 8b each made of a steel plate. The slots extend in a direction perpendicular to the direction of machining and open into the accommodation space portion 5. As shown in FIGS. 5B and 5C, the lock plates 8a and 8b are formed such that the plates can be inserted into the accommodation space portion 5 through the insertion holes 10 from both sides. The lock plates 8a and 8b have front-end portions provided with arc-shaped recessed portions 8c and 8d, respectively, formed along the outer surface of the gas cylinder 6. When the front ends of the two lock plates 8a and 8b are abutted against each other, the recess portions 8c and 8d form a hole 9 for visual check at the seam between them. The inside of the accommodation space portion 5 can be seen from the opening 5a through the hole 9 for visual check.

Threaded holes 11a are formed in the rear surface of the cam slider 3 and extend through the walls near the rear surface and through the insertion holes 10. Threaded holes 8e are formed in the lock plates 8a and 8b, respectively, at positions corresponding to the threaded holes 11a when both front-end portions are in abutment with each other. As shown in FIG. 5A, the lock plates 8a and 8b are attracted and held to the rear walls 10a of the insertion holes 10 by inserting the lock plates 8a into the insertion holes 10 and tightening the plates with the bolts 11 while their ends are in abutment with each other. As a result, under normal state, a gap of about 0.5 mm, for example, is maintained between the rear end surface of the gas cylinder 6 accommodated in the accommodation space portion 5 and the front surfaces of the lock plates 8a, 8b.

The lock plates 8a and 8b prevent the gas cylinder 6 from coming off from the opening 5a for insertion and withdrawal of the gas cylinder 6 that is the resilient member. At the same time, the lock plates support the rear end of the gas cylinder 6. Accordingly, if the gas cylinder 6 operates after machining and the piston rod 6a protrudes, the pressure is applied to the lock plates 8a and 8b, thus returning the cam slider 3 to its initial position.

The front-end portions of the lock plates 8a and 8b are shaped arcuately substantially in conformity with the circular shapes of the accommodation space portion 5 and gas cylinder 6. Therefore, the gas cylinder 6 being a resilient member can be taken out of the accommodation space portion 5 simply by extracting the arcuately shaped front-end portions from the outer wall surface of the accommodation space portion 5 without the need to completely withdraw the lock plates 8a and 8b from the insertion holes 10.

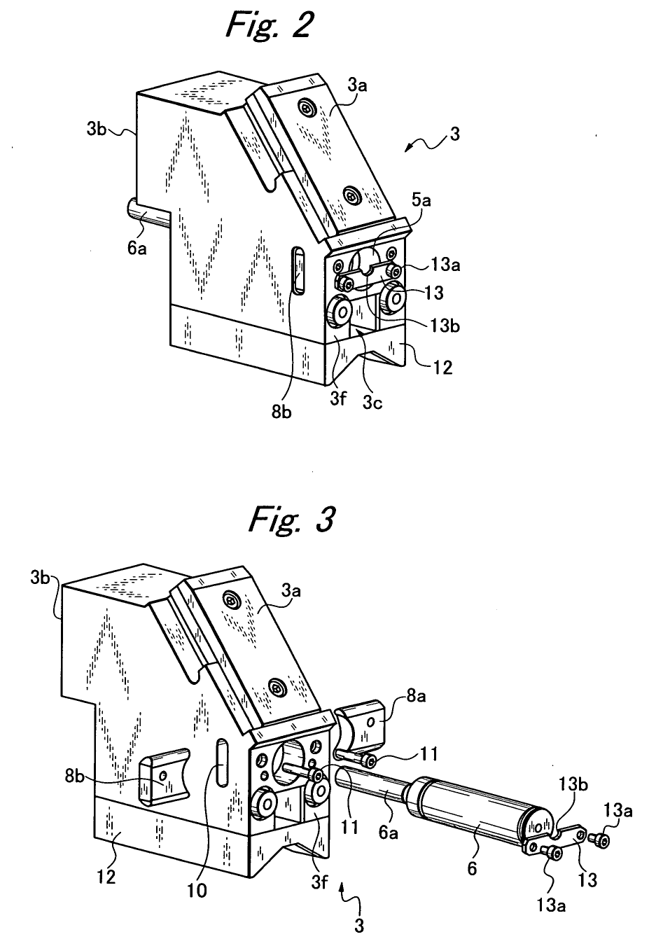

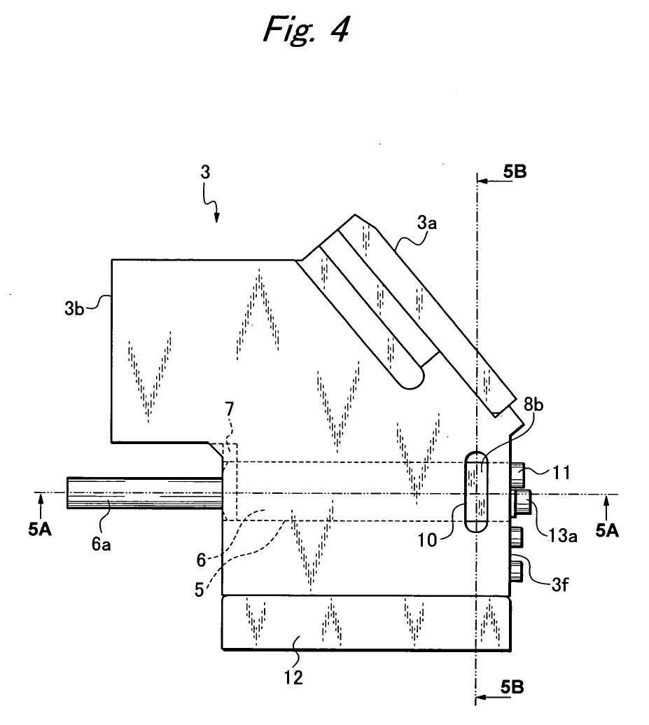

Furthermore, as shown in FIGS. 1 and 2, a secondary safety cover 13 in the form of a flat plate is placed over a substantially half portion of the outside of the opening 5a and held to the rear wall surface 3f with bolts 13a. This prevents the gas cylinder 6 being a resilient member from springing out inadvertently. That is, the safety is further enhanced. An arcuate cutout 13b is formed in the central side portion of the secondary safety cover 13 to have a better look of the inside.

In the present embodiment, the insertion holes 10 are formed in the cam slider 3 itself to form a separate lock plates 8a and 8b. The invention is not limited to this embodiment. A separate member forming the same lock plate subassembly may be held to the cam slider 3 with bolts.

When the cam slider-returning mechanism constructed as described above is serviced, for example, if the bolts 11 are loosened and taken out from behind the cam slider 3 for ease of work as shown in FIGS. 1 and 2, and if the resilient member 6 is in normal state, there is a gap between the lock plates 8a and 8b. Therefore, a rod can be inserted from the opening 5a and the lock plates 8a and 8b can be moved by the tip of the rod with small resistance in both outward directions. Then, as shown in FIG. 5C, the diameter of the hole 9 for visual check substantially agrees with the outside diameter of the opening 5a. Then, the bolts 13a are removed, and the secondary safety cover 13 is removed. The resilient member 6 in the accommodation space portion 5 is withdrawn through the opening 5a. This sequence of operations constitutes a normal work.

However, where the resilient member 6 is not in normal state, i.e., where the biasing force remains, if the bolts 11 are removed and an attempt is made to move the lock plates 8a and 8b outwardly, the lock plates 8a and 8b are pressed against the rear wall surfaces of the insertion holes 10. Because of the magnitude of the resistive force, the lock plates may not be removed easily if the lock plates are pushed by the tip of the rod. The worker can easily recognize this fact, and judge that the resilient member 6 is in abnormal state. In this way, the worker is relieved from a dangerous work. In this case, the resilient member 6 is held to prevent from being sprung out, using a special tool. Then, the lock plates 8a and 8b are moved laterally and placed in a safe state. Subsequently, the resilient member 6 is taken out. In this way, the resilient member 6 can be withdrawn rearward. This improves the efficiency of the work and secures safety.

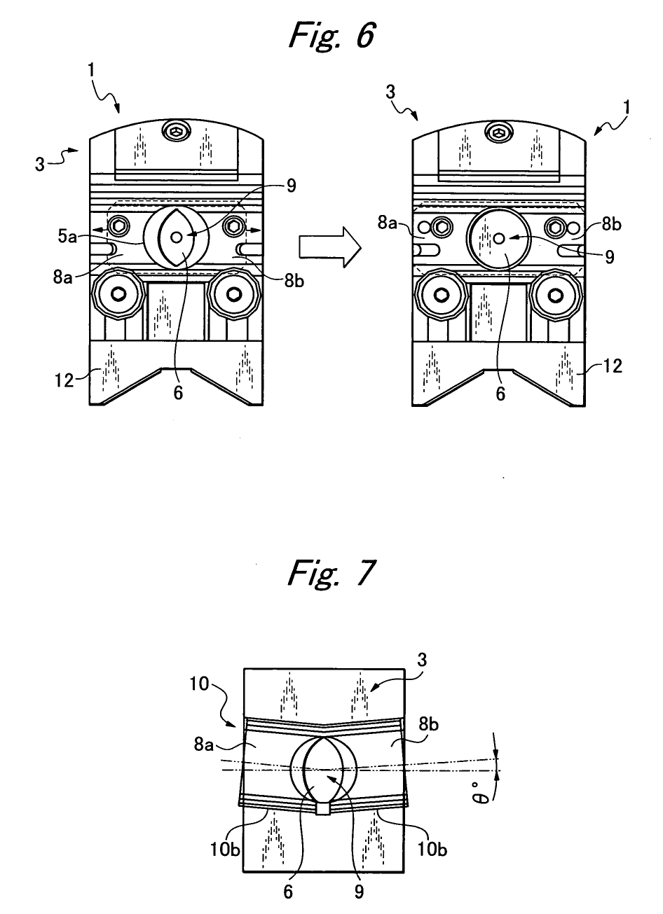

FIG. 6 shows a cam slider-returning mechanism according to a second embodiment of the present invention. The front-end surfaces of lock plates 8a and 8b are moved outwardly into positions where the resilient member 6 can be withdrawn from the accommodation space portion 5. Under this condition, the length of the lock plates 8a and 8b is set small to prevent the lock plates 8a and 8b from protruding outwardly from the maximum lateral width (width in FIG. 6) of the cam slider 3 defined by the end surface positions. The second embodiment is similar to the first embodiment in other respects. Therefore, detailed description of the portions of the second embodiment similar to their counterparts of the first embodiment is omitted. Consequently, when the resilient member 6 is inserted and withdrawn, one end surface of the lock plates 8a and 8b does not protrude from the side surface of the cam slider 3. Hence, press tools 1 can be juxtaposed laterally at short intervals. This is convenient for high-density arrangement of the press tools.

FIG. 7 shows a cam slider-returning mechanism according to a third embodiment of the invention. A cam slider 3 has insertion holes 10 tilted downward at an angle of θ toward the center of an accommodation space portion 5. In this structure, two lock plates 8a and 8b are attracted toward the center by their own weights. It is easy to insert a resilient member. It is unlikely that the resilient member 6 is moved outwardly due to vibrations and comes off.

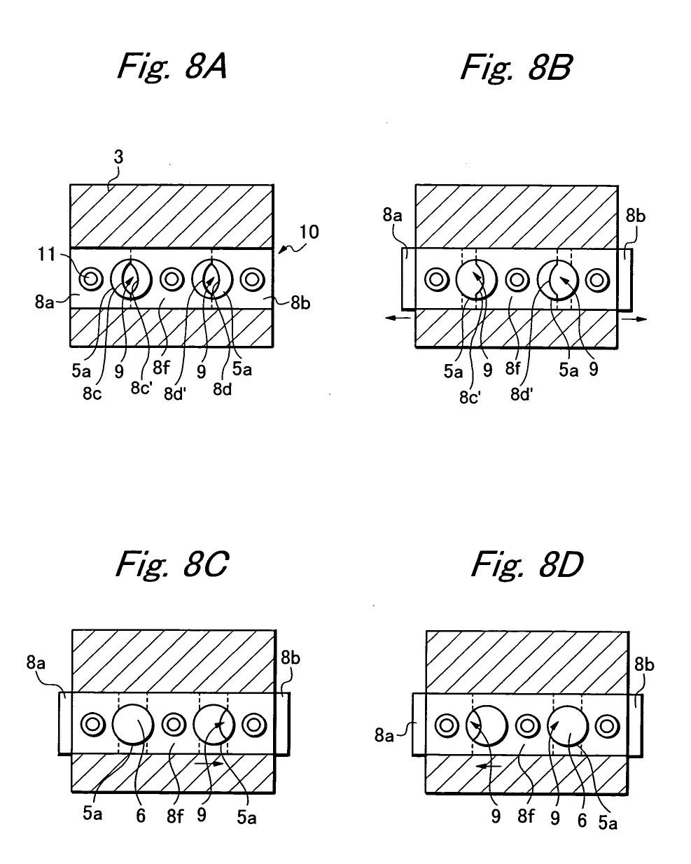

A cam slider-returning mechanism according to a fourth embodiment of the invention is shown in FIGS. 8A-8D. A cam slider 3 has plural resilient members 6 and their accommodation space portions 5. Three lock plates 8a, 8b, and 8f are inserted in an insertion hole 10 through which two accommodation space portions 5 extend in mutually perpendicular directions. The lock plates 8a and 8b are located on the outer sides. The lock plate 8f is inserted in the center. The outer lock plates 8a and 8b have front-end portions provided with arcuately shaped recessed portions 8c and 8d in the same way as in the first embodiment. Symmetric, arcuately shaped recessed portions 8c′ and 8d′ opposite to the recessed portions 8c and 8d are formed in the left and right end portions of the central lock plate 8f. The central lock plate 8f and outer lock plates 8a and 8b cover the two accommodation space portions 5 excluding the hole 9 for visual check.

Where the resilient member 6 is taken out, one outer lock plate 8a is first shifted in an outward direction (to the left in the figure) as shown in FIG. 8B. Then, the central lock plate 8f is shifted in the reverse outward direction (to the right in the figure) as shown in FIG. 8C. The resilient member 6 in the accommodation space portion 5 is withdrawn. Then, as shown in FIG. 8D, the central lock plate 8f is shifted to the left, and the resilient member 6 in the accommodation space portion 5 is withdrawn. In this way, the central lock plate 8f is shifted to the right or left to permit the resilient member 6 to be withdrawn from the opening 5a. Where plural resilient members 6 are mounted on the cam slider 3 of the horizontally elongated press tool 1, they can be taken out safely.

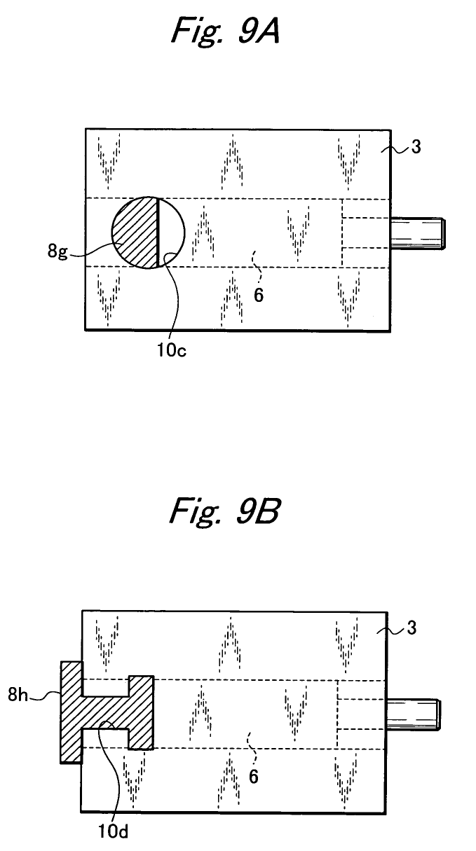

FIGS. 9A and 9B show other embodiments of the lock plates and their insertion holes. As shown in FIG. 9A, a lock plate 8g is provided with a cylindrical insertion hole 10c. The portion of the lock plate 8g that corresponds to the insertion hole 10c is shaped like a round rod as a whole. The portion of the rod-like portion against which the rear end surface of the resilient member 6 abuts is made flat.

As shown in FIG. 9B, a lock plate 8h has a substantially H-shaped cross section and is provided with an insertion hole 10d of T-shaped cross section. The hole 10d opens into the rear surface of the cam slider 3. The lock plate 8h extends between the insertion hole 10d and the rear surface of the cam slider 3.

In the above embodiments, two lock plates are used for one resilient member. The invention is not limited to this structure. One lock plate may be used for one resilient member. For example, a hole for visual check and a through-hole through which a resilient member can pass may be formed in one lock plate.

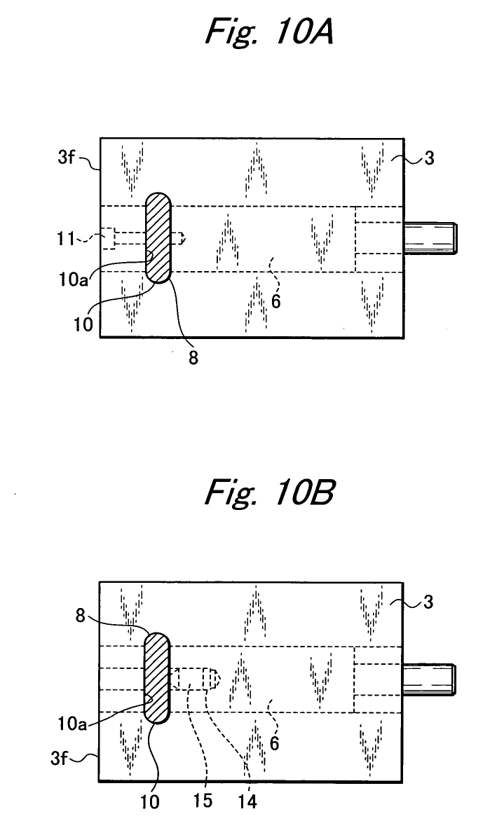

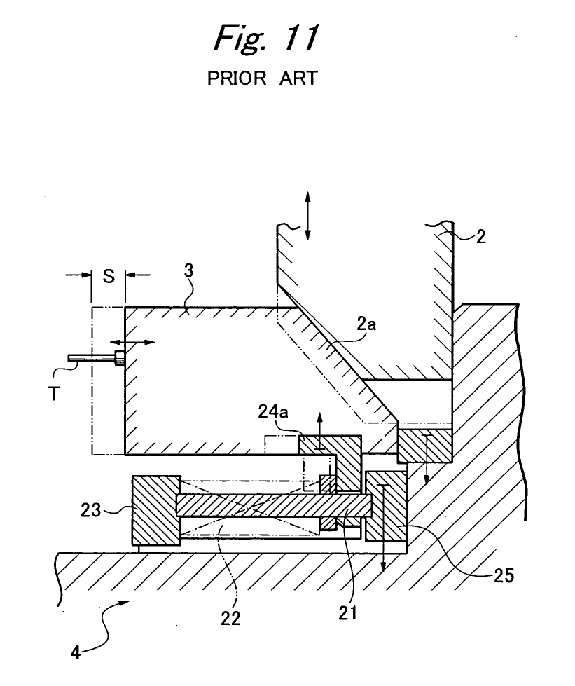

FIGS. 10A and 10B illustrate methods of holding a lock plate subassembly. In the method according to the first or second embodiment and illustrated in FIG. 10A, the lock plate subassembly is tightened with a bolt 11. In the method illustrated in FIG. 10B, a ball plunger 15 is mounted within a holding hole 14. The lock plate subassembly 8 is pushed rearward to hold the lock plate subassembly. The lock plate subassembly 8 can be placed in position against the biasing force of the front end of the ball plunger 15 by pushing the lock plate subassembly 8 into the insertion hole 10 without tightening the lock plate subassembly with screws. The lock plate subassembly 8 can be pushed against the rear wall surface 10a of the insertion hole 10 of the lock plate subassembly 8 and held there by the repulsive force of the ball plunger 15.

1. A cam slider-returning mechanism for use with a press tool having a cam driver capable of moving up and down, a cam slider which has a tilted cam surface making sliding contact with the cam driver and which is thereby slid in a direction of machining, a cam base supporting the cam slider and guiding sliding motion of the cam slider, and a returning mechanism for returning the cam slider to its original position after the cam slider has been slid in the direction of machining, said cam slider-returning mechanism comprising:
at least one accommodation space portion formed in a lower portion of the cam slider or under the cam slider and extending in a direction in which the cam slider moves, the accommodation space portion having front and rear surfaces that are open;
at least one resilient member withdrawably received in the accommodation space portion;
insertion holes formed in both sidewalls of the accommodation space portion near its rear end in a direction perpendicular to a longitudinal direction of the accommodation space portion; and
a lock plate subassembly capable of being inserted in the insertion holes, the lock plate subassembly providing a cover over at least a part of the accommodation space portion, the lock plate subassembly supporting a rear end of the resilient member.

2. A cam slider-returning mechanism according to claim 1, wherein said lock plate subassembly is provided with a hole permitting visual check of inside of the accommodation space portion in which the resilient member is accommodated.

3. A cam slider-returning mechanism according to claim 2, wherein said lock plate subassembly is made of two lock plates each made of a flat plate, each of the lock plates having a front-end portion provided with a recessed portion, and wherein the recessed portions of the two lock plates are abutted against each other to form said hole permitting visual check.

4. A cam slider-returning mechanism according to claim 3, wherein the recessed portions in the front-end portions of said lock plates substantially conform in shape to a part of the cross-sectional shape of the accommodation space portion.

5. A cam slider-returning mechanism according to claim 4, wherein said insertion holes are tilted downwardly toward an axis of said accommodation space portion.

6. A cam slider-returning mechanism according to claim 3, wherein said lock plate subassembly is held by means of holding means after being loosely fitted in said insertion holes.

7. A cam slider-returning mechanism according to claim 1, wherein said lock plate subassembly is so shaped that it does not protrude outwardly from a maximum lateral width of the cam slider defined by both side surfaces of the cam slider as viewed in the direction of the machining when the lock plate subassembly has been moved outwardly to permit the resilient member to be withdrawn from the accommodation space portion.

8. A cam slider-returning mechanism according to claim 2,
wherein said resilient member is plural in number and juxtaposed;
wherein said accommodation space portion is plural in number and juxtaposed; and
wherein said lock plate subassembly is made of end lock plates disposed on opposite ends of the insertion holes and a central lock plate disposed between the end lock plates and provides a cover over the accommodation space portions excluding the hole for visual check.

9. A cam slider-returning mechanism according to claim 2, wherein said lock plate subassembly is so shaped that it does not protrude outwardly from a maximum lateral width of the cam slider defined by both side surfaces of the cam slider as viewed in the direction of the machining when the lock plate subassembly has been moved outwardly to permit the resilient member to be withdrawn from the accommodation space portion.

10. A cam slider-returning mechanism according to claim 3, wherein said lock plate subassembly is so shaped that it does not protrude outwardly from a maximum lateral width of the cam slider defined by both side surfaces of the cam slider as viewed in the direction of the machining when the lock plate subassembly has been moved outwardly to permit the resilient member to be withdrawn from the accommodation space portion.

11. A cam slider-returning mechanism according to claim 4, wherein said lock plate subassembly is so shaped that it does not protrude outwardly from a maximum lateral width of the cam slider defined by both side surfaces of the cam slider as viewed in the direction of the machining when the lock plate subassembly has been moved outwardly to permit the resilient member to be withdrawn from the accommodation space portion.

12. A cam slider-returning mechanism according to claim 5, wherein said lock plate subassembly is so shaped that it does not protrude outwardly from a maximum lateral width of the cam slider defined by both side surfaces of the cam slider as viewed in the direction of the machining when the lock plate subassembly has been moved outwardly to permit the resilient member to be withdrawn from the accommodation space portion.

13. A cam slider-returning mechanism according to claim 6, wherein said lock plate subassembly is so shaped that it does not protrude outwardly from a maximum lateral width of the cam slider defined by both side surfaces of the cam slider as viewed in the direction of the machining when the lock plate subassembly has been moved outwardly to permit the resilient member to be withdrawn from the accommodation space portion.
